(19) United States
(12) Patent Application Publication
(10) Pub. No.: US 2019/0268906 A1
(43) Pub. Date: Aug. 29, 2019

(54) LOCATION DEPENDENT CONTROL OVER TRANSCEIVER CHARACTERISTICS

(71) Applicant: goTenna, Inc., Brooklyn, NY (US)

(72) Inventor: Jorge Perdomo, New York, NY (US)

(21) Appl. No.: 16/137,438

(22) Filed: Sep. 20, 2018

Related U.S. Application Data
(60) Provisional application No. 62/560,984, filed on Sep. 20, 2017.

(51) Int. Cl. H04W 72/04; H04W 4/021; G01S 19/13

(52) U.S. Cl. CPC H04W 72/0453; H04W 72/085; G01S 19/13; H04W 4/021

(57) ABSTRACT

A system and method for controlling a radio transceiver, having a geolocation determining system, and a geospatial database which stores rules or constraints dependent on location, in conjunction with a radio having controllable parameters responsive to the database, such that the geolocation determining system provides a georeference to the database, and retrieves appropriate parameters for operating the radio at the respective location. The transmitter is controlled to operate within constraints and parameters appropriate for the location. The receiver may be configured to receive modulated signals appropriate for the determined location dependent on the database.

### CROSS REFERENCE TO RELATED APPLICATIONS

The present application claims benefit of priority from U.S. Patent Application No. 62/560,984, filed Sep. 20, 2017, under 35 U.S.C. § 119(e), the entirety of which is expressly incorporated herein by reference in its entirety.

### FIELD OF THE INVENTION

The present invention relates to the field of radio frequency transmission control systems, and more particularly a geolocation or geopolitical boundary responsive control system.

### BACKGROUND OF THE INVENTION

All references cited herein are expressly incorporated herein by reference in their entirety.

The integration of GPS receivers in common platforms with radio frequency transceivers is well established. For example, the wireless e911 phase 2 mandate drove the integration of GPS functionality into smartphones. en.wikipedia.org/wiki/Enhanced_9-1-1; en.wikipedia.org/wiki/GPS_navigation_device. Typically, the control over the transceiver is independent of the GPS or other geolocation determining system. This may be for a number of reasons. For example, when the GPS system suffers a cold start, it may take up to 15 minutes for a GPS unit to determine its location. en.wikipedia.org/wiki/Time_to_first_fix; gpsworld.com/wirelessinfrastructurecalculating-time-first-fix-12258/. Second, interference or spoofing may render the GPS determined location inaccurate. en.wikipedia.org/wiki/Global_Positioning_System. Third, the GPS subsystem consumes power, and may be deactivated, and thus unavailable. Therefore, while GPS receivers may be physically available within the platform, reliance on the GPS functionality is deterred by various circumstances where it is functionally unavailable. As a result, radio transceivers are typically designed without critical reliance on availability of an accurate GPS signal. Assisted GPS supplements satellite information with cellular tower distance and location information, to speed up time to first fix and accuracy. en.wikipedia.org/wiki/Assisted_GPS; www.researchgate.net/profile/Carles_Fernandez-Prades/publication/233859851_Assisted_GNSS_in_LTE-Advanced_Networks_and_Its_Application_to_Vector_Tracking_Loops/links/0912f50c48c60d1add000000/Assisted-GNSS-in-LTE-Advanced-Networks-and-Its-Application-to-Vector-Tracking-Loops.pdf?origin=publication_detail.

Ad hoc networks or mesh networks are also known. These protocols permit peer-to-peer communications between devices over a variety of frequency bands, and a range of capabilities. In a multi-hop network, communications are passed from one node to another in series between the source and destination. In a long range radio repeater network, signal may be communicated hundreds of miles or globally. This increases the risk that the signal will cross geopolitical boundaries that restrict communication parameters. Also, human mobility is high, and travelers may move across many countries in a short amount of time.

An old class of wireless communication technologies comprises voice communication on narrowband analog radio channels, such as paired Walkie-Talkies and Citizens Band (CB) Radio. The set of Citizen's Band services defined by Federal Communications Commission regulations includes the Family Radio Service (FRS) and General Mobile Radio Service (GMRS) which operate at 462 and 467 MHz, Multi-Use Radio Service (MURS) which operates at 150 MHz, the original Citizens Band Radio (CB) which operates at 27 MHz and more recently at 49 MHz, Wireless Medical Telemetry Service (WTMS) at 610, 1400 and 1430 MHz, the Low Power Radio Service (LPRS) at 216-217 MHz, and the Medical Implant Communications Service (MICS) at 402 MHz which are in some cases unlicensed. In addition, the ISM 902-928 MHz band available in the US, and 869 MHz in Europe, as available as unlicensed frequencies.

It is noted that certain restrictions and performance requirements on use may be different not only across the different channels; but also, critically, they will often vary widely across different RF jurisdictions which are typically regulated by governments at the national level.

Typically, the highly regulated bands will be geographically licensed, and therefore the transceiver device may require a GPS receiver to determine what bands are available for use. An alternate, however, is to provide a radio frequency scan function to listen for characteristic communications and geographic and/or licensing information, before any communications are sent. A transceiver device may therefore conduct a handshake negotiation with a base station in a particular location to authorize its usage and to the extent applicable, log usage and charge a prepaid or postpaid user account for the usage.

There are some recent and earlier examples of prior art that address one or more of these issues. For example, see: US2010/0203878, US2008/0200165, WO2012/078565, U.S. Pat. No. 6,415,158, US2012/0023171, US2010/0029216, U.S. Pat. Nos. 8,503,934, 8,165,585, 7,127,250, 8,112,082, WO2012/116489, U.S. Pat. Nos. 7,512,094, 8,126,473, US2009/0286531, U.S. Pat. Nos. 7,400,903, 6,647,426, US2009/0109898, and U.S. Pat. No. 8,248,947, each of which is expressly incorporated herein by reference. These citations deal with wireless communications systems with two available bands, which may comprise both licensed and unlicensed bands.

### SUMMARY OF THE INVENTION

The present technology provides a transceiver capable of transmitting over a range of parameters, such as frequency, amplitude, output power, modulation, protocol patterns (hopping counts, timing, etc.), at least a portion of a parametric space being legally restricted or prohibited. A geolocation system determines the location of the transceiver, performs a lookup of parametric constraints based on the location, and thereafter operates according to the location-based parametric constraints.

For example, each country may have different regulations on frequency, power, modulation, air-time behavior (protocols), and the like, within various frequency channels and bands. A GPS or other geolocation system, link.springer.com/content/pdf/bfm%3A978-1-4614-1836-8%2F1.pdf; en.wikipedia.org/wiki/Geolocation, is used to determine geolocation or geopolitical jurisdiction. A database of pre-existing rules, regulations, preferences and/or constraints is then accessed based on the geolocation or geopolitical boundary information, and the retrieved information is then used to control the transmitter or receiver, or transceiver in a manner appropriate for that jurisdiction.

Typically, the transmitter and respective receiver will be located sufficiently close that they are subject to the same constraints. However, in some cases, the distance may be sufficient that the transmitter and receiver are not symmetrically constrained. In that case, communication according to implied common parameters may be unreliable or unavailable. That is, the transmitter section of each transceiver is constrained by a set of location-based rules, and the rules may differ for the various transceivers. However, the receiver is typically not constrained by the rules, and may receive communications which violate rules if transmitted. If both the transmitter and receiver search the database for proximate geolocations within the communication range of each, a set of permissible communication parameters may be mutually determined, without direct communication according to symmetric communication parameters, that permits the two to communicate, within a limited search space for mutually acceptable communication parameters. More generally, the rules will typically constrain the transmitter, but only guide the receiver, of a transceiver device.

Further, there may be other asymmetries. For example, one device may be licensed to operate in a certain manner, while a communication partner is not. Similarly, one device may possess transmission capability that is absent in another device. However, the receiver may be more capable than the transmitter, and therefore permit asymmetric bidirectional communications to occur within the various rule-based and other constraints.

In some cases, the transceiver may delegate modulation and demodulation to a paired device, such as a smartphone. For example, the quadrature radio data may be passed over a Bluetooth link between the transceiver and the smartphone. In this case, cognitive software radio logic resides wholly within the smartphone. However, in some cases, the transceiver is intended to operate in a stand-alone mode. Further, the generic software-define radio (SDR) architecture may have a higher power consumption than an optimized hardware design. Preferably, the transceiver supports both options, with SDR available as an option, for both transmit and receive, or for receive only. In many cases, the communication channel will be less than 24 kHz bandwidth, permitting use of audio grade Bluetooth components. In an SDR system, the transceiver provides a digital communication interface to a microprocessor, which receives data defining a signal to be transmitted, converts the data to an analog signal, which may be a quadrature modulated signal. The microprocessor also receives data which defines an available communication channel within a band. In some cases, there are multiple bands, and multiple radios may be controlled by a single processor. The analog signal is then modulated onto a carrier for the channel, and transmitted. In a stand-alone mode, the data to be transmitted is stored in a memory. This may be received in advance, or a user interface provided to define the contents of the memory. The processor then reads the data from the memory, selects the channel/band for transmission, and modulates the radio transmission, or feeds data to a hardware modulator, which then transmits the signal.

The receiver has two operation modes. In a first mode, it is expecting a transmission on a predetermined channel, and demodulates transmissions received on that channel, or digitizes a baseband downconverted signal and passes the data stream to the linked device which performs SDR functions. A complex protocol with channel switching may be implemented, by the transceiver processor and/or a host processor of the SDR system. In a second mode, the receiver is listening for transmissions, but is not expecting any such transmissions. In this case, it may have a control channel to monitor, or there may be a number of possible channels that require monitoring. In the latter case, two options may be available. A time-multiplexed monitoring may be provided to scan the different channels for communications. This risks only receiving an indecipherable portion of a communication on a monitored channel, or missing burst communications entirely. Another option is a frequency aliased monitoring, in which multiple channels are superposed and simultaneously monitored for existence of signal components. When signal is detected in the aggregate, the aliasing may be reversed, and the channel of interest identified and then monitored. Alternately, if the channels are adjacent, a wideband radio may monitor the entire band.

Thus, the receiver and transmitter may employ distinct technologies and implementations. In other embodiments, the receiver and transmitter are operated symmetrically, for example in a half-duplex mode in the same channel, or on a pair of channels which share common signal characteristics. This is especially advantageous in ad hoc communications, where multiple transceivers engage in group communications.

According to a preferred embodiment, the radio transceiver is provided in a housing which does not include the GPS receiver, and coupled using a low energy radio frequency communication link, such as Bluetooth 4.0, to a smartphone or other GPS-enabled device, which itself performs the database lookup and communicates the communication parameters to the transceiver. Of course, the GPS may be included within the transceiver and the database may be as well. The transceiver may be a goTenna® Pro or Mesh device, or other radio transceiver, and may operate on any permissible radio frequency band.

The database may also be housed in the same enclosure as the radio transceiver, which permits the GPS enabled device to communicate location information in an industry standard location code, such as NMEA data. www.gpsinformation.org/dale/nmea.htm. For example, a separate GPS with industry standard Bluetooth communication capability, may provide location information if not built into the unit, and therefore a smartphone or other intelligent device is not required. Further, this facilitates ensuring compliance with the rules. For example, a universal mode or transmission-free mode may be assumed when accurate GPS data is not available, permitting the transceiver to operate in a stand-alone mode, or receive-only mode.

The location information may also be derived from other sources, such as a pattern of WiFi SSID or MAC addresses, using triangulation. The location information may also be shared by other units which can communicate through any kind of side-channel, e.g., Bluetooth, or it could also theoretically be manually input by a user, which is not preferred.

The key distinction from previous data inputs used to modify the RF behavior of other cognitive transceivers is that this information is tied to specific geographic locations—like countries, states, or privately managed subdivisions, of allowable RF behavior. Other automatic cognitive radios can and do take in information at a specific location, however the information they use is better described as “environmental” and is specific to a location only in the context of a particular moment in time and it is considered only in an abstract manner, it is not tied to specific geospatial space.

In a typical case, the system seeks to determine which geopolitical boundary the transceiver lies within, and perform a lookup of the relevant acceptable radio frequency transmission parameters acceptable within that geopolitical boundary. Further boundaries may be imposed at a lower private level, like for example via private enterprises that may only allow operation of certain RF parameters in certain geospatial locations. There may be other factors, that define the parameter set, such as other radio traffic or interference in the area, proximity to sensitive equipment, existence of an emergency, licensed operation, etc., may all influence the available parameter set, however the core is geospatial information.

The radio transceiver device preferably has a non-volatile memory to store a last location fix, to provide a warm-fix capability, and permit autonomous operation.

The typical transceiver device uses a computerized host, such as a smartphone, mobile computer, or intelligent appliance or sensor/actuator system, together with an internal radio or external radio-frequency adaptor to enable communication on a point-to-point basis via a licensed or unlicensed band, e.g., CB, MURS, FRS, GMRS, 868 MHz, ISM 902-928, or other spectrum, generally in the range 19 MHz-60 GHz. A preferred frequency range for operation is in the VHF bands at about 150 MHz-175 MHz. However, the technology is not so limited. For example, the band usage may include 25-50 MHz; 72-76 MHz; 150-174 MHz; 216-220 MHz; 406-413 MHz; 421-430 MHz; 450-470 MHz; 470-512 MHz; 800 MHz; 806-821/851-866 MHz; 900 MHz (896-901/935-940 MHz), as well as higher, intermediate, or lower frequencies.

When the computerized host includes cellular communication capability, the transceiver preferably provides access to bands other than the cellular bands within the phone, and thus permits use when the licensed cellular network is unavailable. Further, the transceiver may provide distinct data processing capabilities, such as secure encryption, analog signal modulation transmission, or transmit power, which may be unavailable on the computerized host. Further, this technology, operating within Federal Communication Commission limits for various bands would generally have greater range than can be obtained using a built-in WLAN operating in the 900 MHz, 2.5 GHz, 5.8 GHz or 60 GHz ISM bands, without excessive power consumption. Thus, in some cases, the transceiver may replicate communication bands available in the computerized host, but with additional radio features or advantageous parameters, such as high gain antenna, high transmit power, etc.

A preferred embodiment provides an external transceiver module which communicates with a smartphone, mobile computer or other computational device providing a human user interface or machine communication interface through a wired connection, such as USB or serial network (RS-232, RS-422, RS-423, RS-485, CAN (ISO 11898-1), J1850, FlexRay, IEEE-1905 (wireline), SPI, I²C, UNI/O, and 1-Wire) or low power, short range wireless communication technology such as Bluetooth, Zigbee or Insteon, Z-wave or the like, or medium range wireless communication technology such as 802.11 a/b/g/n/ac/ad radio. The transceiver module receives the communications payloads from the user interface device, and formats and retransmits the payloads, for example in the Multi Use Radio Service (MURS) at about 150 MHz with 500 mW-2 W transmit power, or likewise the interface device receives wirelessly transmitted payloads from the transceiver device. The transceiver module may also receive all or a portion of the data from another transceiver module, store the received data and transmit a message comprising all or a portion of the data to another transceiver module. Of course, other technologies may be employed for the local communication with the user/machine interface device and the telecommunication with a remote system. Generally, the transceiver module is self-powered with an internal rechargeable or primary battery, fuel cell, energy harvesting generator/recharger, crank or kinetic generator, wireless induction, solar cell, power drawn from mobile phone's headphone audio jack, iOS Lightning port, supercapacitor, main line power (120 V plug), or USB power (e.g., from a smartphone, which can also provide a wired data connection.) USB 2.0 provides limited power (5V, 500 mA), while USB 3.0 and 3.1 provide higher power limits (5V, 900 mA and 2100 mA). In some cases, an energy harvesting generator may be used to obviate the need for a recharger or primary battery.

According to one embodiment, the transceiver acts as a node within a multihop ad hoc network (MANET). That is, a transceiver is capable of forwarding packets of information according to a MANET routing protocol. Since geographic location information may be helpful for the determination of acceptable routing radio parameters, that location can also be used for routing. In a non-location-aware MANET routing protocol, a node does not know the physical topography of the network, and merely has indication of distance. This leads to a need for communication loop truncation, and other measures to ensure efficiency. When location information is available, a path through the network may be defined, with some measure of communication risk, such as sparse node density, radio obstructions, and the like, including in routing optimization. Indeed, over short time intervals, location codes may replace transceiver identifier codes in routing packets. Indeed, if two transceivers are near each other and employed in a protocol that is memoryless, then they may share a location code, so long as interference detection and abatement is employed. This, in turn, permits the administrative information for routing communications to be potentially simplified as compared to node-identification protocols. Over longer time periods, mobility information must also be included, and therefore as static location may be insufficient to provide stable routing. Over long distances, changes in permissible radio operation parameters may be present, and the radios are multimode to automatically select the correct transmit parameters and translate the received message into the proper form for retransmission. In the event of a routing failure, a reliable protocol will require some acknowledgement, either of an explicit failure, or a failure to receive an acknowledgement within a certain period. In some use cases, it is inefficient and difficult to transmit a full history of communications, such that an acknowledgement can be routed back to the source, or for each step of the transmission to individually acknowledge retransmission of each packet. Therefore, a preferred acknowledgement mechanism provides proactively maintained routing table, which is efficiently propagated across the network using low priority transmissions, which is used to communicate a message having an identifier, a destination identifier (unit ID and location), and message data, which is geographically routed to the destination according to the routing table. The acknowledgement(s) may advantageously be propagated back to the sender appended to routing messages. While this may result in slow acknowledgment, it permits a system-wide global assessment of communication reliability (based on comparison of messages sent and acknowledgements received), which can then guide the routing protocol to avoid communications through unreliable nodes or regions, for example. In some cases, the administrative information may be communicated on a control channel, or out of band with respect to the messages.

In some cases, a geolocation system may be used to in a communications protocol, and thus may have utility other than for selecting a georeferenced transceiver parameter record from a database. For example, a location-responsive ad hoc radio routing protocol may employ the geolocation information. Further, in some cases, the geolocation may define a position on a topographic map, which can propose transceiver parameters appropriate for the topology, especially of the location of the receiver with respect to the transceiver for a communication link is also known. For example, during initial negotiation for communications, the radios may exchange locations. Thus, if the terrain between the radios is open, a different set of parameters may be used as compared to mountainous, forested, urban, marine, etc.

If the geolocation determining device (e.g., GPS, GNSS) is within the transceiver, the transceiver may operate autonomously, without a smartphone or associated user interface device, in accordance with the georeferenced constraints and parameters, and may serve as distributed repeaters/relay nodes. See, U.S. Pat. Nos. 6,628,620; 6,718,394; 6,754,192; 6,763,013; 6,763,014; 6,807,165; 6,836,463; 6,845,091; 6,850,532; 6,870,846; 6,873,839; 6,894,985; 6,904,275; 6,907,257; 6,917,985; 6,954,435; 6,954,449; 6,954,790; 6,961,310; 6,975,614; 6,977,938; 6,980,524; 6,980,537; 6,986,161; 6,990,075; 7,007,102; 7,027,426; 7,031,288; 7,061,924; 7,068,600; 7,068,605; 7,079,509; 7,079,552; 7,082,117; 7,085,290; 7,092,391; 7,099,296; 7,113,796; 7,133,391; 7,142,866; 7,151,769; 7,155,518; 7,177,295; 7,184,421; 7,190,678; 7,197,016; 7,209,978; 7,212,504; 7,216,282; 7,224,954; 7,242,671; 7,251,238; 7,266,085; 7,266,104; 7,281,057; 7,299,038; 7,304,972; 7,317,898; 7,327,683; 7,330,694; 7,333,458; 7,339,897; 7,346,167; 7,349,362; 7,352,750; 7,356,329; 7,366,111; 7,366,544; 7,369,948; 7,380,317; 7,382,765; 7,389,295; 7,394,798; 7,394,826; 7,408,911; 7,414,977; 7,415,019; 7,418,238; 7,420,952; 7,420,954; 7,428,221; 7,443,822; 7,450,517; 7,453,864; 7,468,954; 7,475,158; 7,480,248; 7,489,653; 7,512,079; 7,516,848; 7,519,071; 7,542,437; 7,548,921; 7,551,892; 7,554,982; 7,561,024; 7,564,842; 7,567,547; 7,567,577; 7,567,673; 7,580,380; 7,580,730; 7,581,095; 7,586,897; 7,590,589; 7,593,377; 7,599,696; 7,603,181; 7,606,176; 7,609,644; 7,616,961; 7,634,230; 7,639,652; 7,639,663; 7,649,852; 7,653,391; 7,656,851; 7,656,901; 7,660,319; 7,668,173; 7,672,307; 7,684,314; 7,698,463; 7,706,282; 7,706,842; 7,715,396; 7,719,987; 7,724,479; 7,725,080; 7,742,399; 7,751,360; 7,756,041; 7,764,617; 7,770,071; 7,773,575; 7,778,235; 7,787,865; 7,796,573; 7,808,987; 7,813,326; 7,814,322; 7,830,805; 7,847,734; 7,849,139; 7,859,465; 7,860,025; 7,860,049; 7,869,601; 7,881,206; 7,881,667; 7,890,112; 7,894,416; 7,898,979; 7,902,973; 7,903,631; 7,906,765; 7,911,962; 7,924,722; 7,924,728; 7,924,796; 7,925,360; 7,929,914; 7,936,732; 7,944,899; 7,948,931; 7,957,355; 7,961,626; 7,961,650; 7,962,101; 7,970,933; 7,974,402; 7,978,612; 7,996,558; 8,018,335; 8,023,423; 8,026,849; 8,031,605; 8,031,720; 8,032,249; 8,032,746; 8,035,509; 8,041,834; 8,050,196; 8,054,819; 8,055,454; 8,059,544; 8,059,578; 8,060,649; 8,064,377; 8,064,416; 8,064,879; 8,072,906; 8,089,970; 8,094,583; 8,102,794; 8,115,617; 8,125,964; 8,132,059; 8,134,950; 8,139,504; 8,144,596; 8,144,619; 8,145,201; 8,149,716; 8,149,733; 8,149,801; 8,160,586; 8,161,097; 8,171,364; 8,175,101; 8,180,352; 8,194,541; 8,199,664; 8,199,677; 8,200,744; 8,208,368; 8,213,409; 8,218,463; 8,218,519; 8,243,603; 8,249,101; 8,254,348; 8,255,469; 8,256,681; 8,270,974; 8,271,449; 8,275,824; 8,284,689; 8,289,182; 8,291,112; 8,298,041; 8,301,294; 8,306,638; 8,315,231; 8,319,658; 8,320,879; 8,330,649; 8,334,787; 8,335,207; 8,335,814; 8,339,948; 8,340,690; 8,341,279; 8,341,289; 8,346,846; 8,351,339; 8,352,420; 8,355,410; 8,363,662; 8,370,697; 8,370,894; 8,392,541; 8,406,153; 8,433,437; 8,437,250; 8,441,958; 8,447,849; 8,447,875; 8,451,744; 8,451,807; 8,452,014; 8,457,005; 8,462,691; 8,472,348; 8,483,616; 8,483,652; 8,488,589; 8,489,765; 8,494,989; 8,496,181; 8,503,309; 8,510,061; 8,520,676; 8,538,458; 8,547,875; 8,553,688; 8,559,442; 8,561,200; 8,571,004; 8,578,015; 8,583,978; 8,588,108; 8,588,126; 8,593,986; 8,595,359; 8,600,830; 8,612,583; 8,619,576; 8,619,789; 8,626,844; 8,630,177; 8,630,275; 8,630,291; 8,638,667; 8,654,627; 8,654,649; 8,665,890; 8,667,084; 8,675,678; 8,681,693; 8,688,041; 8,693,399; 8,699,333; 8,699,368; 8,699,377; 8,702,506; 8,711,818; 8,712,056; 8,712,441; 8,724,508; 8,725,274; 8,731,708; 8,738,944; 8,743,698; 8,743,768; 8,743,866; 8,744,419; 8,744,516; 8,750,242; 8,750,898; 8,751,159; 8,756,449; 8,761,285; 8,774,050; 8,777,752; 8,780,953; 8,787,392; 8,792,860; 8,798,593; 8,798,645; 8,798,647; 8,799,510; 8,800,010; 8,806,633; 8,817,665; 8,819,191; 8,821,293; 8,824,471; 8,825,103; 8,830,837; 8,831,635; 8,832,428; 8,837,277; 8,842,630; 8,855,010; 8,856,252; 8,856,323; 8,861,390; 8,862,774; 8,867,329; 8,868,027; 8,873,391; 8,873,526; 8,874,477; 8,874,788; 8,879,604; 8,879,613; 8,885,501; 8,885,630; 8,891,534; 8,891,588; 8,902,963; 8,908,536; 8,908,621; 8,908,626; 8,923,163; 8,923,186; 8,923,422; 8,925,084; 8,934,366; 8,934,496; 8,937,886; 8,942,197; 8,942,301; 8,948,046; 8,948,229; 8,949,810; 8,949,959; 8,954,582; 8,958,417; 8,964,629; 8,964,762; 8,964,773; 8,966,046; 8,970,394; 8,971,188; 8,982,708; 8,984,277; 9,001,645; 9,001,669; 9,001,676; 9,001,787; 9,008,092; 9,013,173; 9,013,983; 9,019,846; 9,020,008; 9,030,939; 9,031,581; 9,037,896; 9,041,349; 9,059,929; 9,060,386; 9,062,992; 9,071,451; 9,071,533; 9,072,100; 9,077,772; 9,081,567; 9,083,627; 9,084,120; 9,088,903; 9,088,983; 9,094,324; 9,100,305; 9,106,555; 9,112,805; 9,118,428; 9,118,539; 9,119,130; 9,124,482; 9,128,689; 9,130,863; 9,143,456; 9,154,370; 9,154,407; 9,155,020; 9,160,760; 9,161,158; 9,166,845; 9,167,558; 9,172,613; 9,172,636; 9,172,738; 9,173,168; 9,176,832; 9,178,772; 9,179,494; 9,185,070; 9,185,521; 9,185,522; 9,185,630; 9,189,822; 9,191,303; 9,197,380; 9,198,203; 9,209,943; 9,210,045; 9,210,589; 9,210,647; 9,215,716; 9,218,216; 9,219,682; 9,225,589; 9,225,616; 9,230,104; 9,231,850; 9,231,965; 9,232,458; 9,236,904; 9,236,999; 9,240,913; 9,247,482; 9,253,021; 9,253,616; 9,264,349; 9,264,863; 9,264,892; 9,266,025; 9,270,584; 9,276,845; 9,277,482; 9,281,865; 9,282,383; 9,286,473; 9,288,066; 9,294,488; 9,300,569; 9,306,620; 9,306,833; 9,306,841; 9,306,902; 9,311,670; 9,317,378; 9,319,332; 9,319,842; 9,325,626; 9,331,931; 9,332,072; 9,338,065; 9,350,635; 9,350,645; 9,350,683; 9,351,155; 9,356,858; 9,356,875; 9,357,331; 9,363,166; 9,363,651; 9,369,177; 9,369,295; 9,369,351; 9,374,281; 9,385,933; 9,386,502; 9,391,784; 9,391,839; 9,391,878; 9,392,482; 9,397,732; 9,398,035; 9,401,863; 9,402,216; 9,407,646; D633,496; RE42,871; RE44,606; 20010018336; 20010024443; 20020039357; 20020069278; 20020133534; 20020145978; 20020178207; 20020191573; 20030139187; 20030153338; 20030161268; 20030165117; 20030172221; 20030200062; 20030202465; 20030202468; 20030202469; 20030202476; 20030202512; 20030204587; 20030204616; 20030204623; 20030204625; 20030210787; 20040015689; 20040015954; 20040022223; 20040022224; 20040025018; 20040028000; 20040028016; 20040029553; 20040042417; 20040042434; 20040057409; 20040071124; 20040090943; 20040095915; 20040103275; 20040157557; 20040160943; 20040190468; 20040203820; 20040213167; 20040218548; 20040218582; 20040219909; 20040233881; 20040264466; 20050013253; 20050041591; 20050041627; 20050041628; 20050053003; 20050053004; 20050053005; 20050053007; 20050053094; 20050054346; 20050073992; 20050078672; 20050090201; 20050128944; 20050135379; 20050152305; 20050152318; 20050157661; 20050175009; 20050190717; 20050191990; 20050220142; 20050220146; 20050221761; 20050227686; 20050227736; 20050233699; 20050254473; 20050254520; 20050255841; 20050256667; 20050259588; 20050265259; 20050265388; 20050267960; 20050275532; 20050286419; 20050289122; 20050289275; 20060002328; 20060004888; 20060007863; 20060023632; 20060023677; 20060026132; 20060029074; 20060034233; 20060052142; 20060062252; 20060064402; 20060079285; 20060083243; 20060088042; 20060089119; 20060098608; 20060117113; 20060126524; 20060126535; 20060155827; 20060167784; 20060176829; 20060176863; 20060206235; 20060227724; 20060239207; 20060268688; 20060291404; 20060291485; 20070035409; 20070035410; 20070038743; 20070046496; 20070046497; 20070046498; 20070064950; 20070070909; 20070080797; 20070080798; 20070083789; 20070087756; 20070091805; 20070101015; 20070110024; 20070110102; 20070115895; 20070127379; 20070127503; 20070153737; 20070153764; 20070195702; 20070195728; 20070195768; 20070195799; 20070201428; 20070223436; 20070238410; 20070247368; 20070280174; 20070280192; 20070286097; 20070296558; 20080019298; 20080019328; 20080040507; 20080051036; 20080062916; 20080064338; 20080095058; 20080107044; 20080144497; 20080159151; 20080165745; 20080171519; 20080189394; 20080195360; 20080198079; 20080198789; 20080198865; 20080207121; 20080232338; 20080240050; 20080247353; 20080261580; 20080262893; 20080267116; 20080273487; 20080291843; 20080307068; 20080310390; 20090002151; 20090003324; 20090003366; 20090031398; 20090046601; 20090046712; 20090086663; 20090086807; 20090135824; 20090147725; 20090197530; 20090210495; 20090216713; 20090219170; 20090219194; 20090245159; 20090282156; 20090303888; 20090313614; 20090323519; 20100014444; 20100032009; 20100061352; 20100062780; 20100091924; 20100094566; 20100097957; 20100123572; 20100125671; 20100125674; 20100174942; 20100202346; 20100235285; 20100254309; 20100284154; 20100306546; 20100317420; 20110004513; 20110007669; 20110019540; 20110057793; 20110078461; 20110080853; 20110085530; 20110099611; 20110128884; 20110133924; 20110158153; 20110200026; 20110205082; 20110225311; 20110225312; 20110228696; 20110228788; 20110231573; 20110235550; 20110235636; 20110255479; 20110267981; 20120014309; 20120030461; 20120039186; 20120039190; 20120044864; 20120100882; 20120113807; 20120113863; 20120113986; 20120117213; 20120117268; 20120117438; 20120155260; 20120155276; 20120155284; 20120155329; 20120155397; 20120155463; 20120155475; 20120155511; 20120158933; 20120182867; 20120188968; 20120213124; 20120230204; 20120230222; 20120230370; 20120233326; 20120233485; 20120236724; 20120250575; 20120254338; 20120258727; 20120258777; 20120307624; 20120307629; 20120307652; 20120307653; 20120307825; 20120320768; 20120320790; 20120320923; 20120324273; 20130010590; 20130010615; 20130010798; 20130013806; 20130013809; 20130016612; 20130016757; 20130016758; 20130016759; 20130016840; 20130018993; 20130019005; 20130022042; 20130022046; 20130022053; 20130022083; 20130022084; 20130024560; 20130028095; 20130028103; 20130028104; 20130028140; 20130028143; 20130028295; 20130031253; 20130051250; 20130055383; 20130064072; 20130067063; 20130080307; 20130083658; 20130088999; 20130089011; 20130094536; 20130094537; 20130100942; 20130121331; 20130121335; 20130124883; 20130128726; 20130128773; 20130138792; 20130151563; 20130188471; 20130191688; 20130201891; 20130215942; 20130219045; 20130219046; 20130219478; 20130223218; 20130223225; 20130223229; 20130223237; 20130223275; 20130227055; 20130227114; 20130227336; 20130250754; 20130250808; 20130250809; 20130250811; 20130250866; 20130250945; 20130250953; 20130250969; 20130251053; 20130251054; 20130279365; 20130279540; 20130283347; 20130283360; 20130288733; 20130290560; 20130311661; 20130336316; 20140006893; 20140016643; 20140022906; 20140029432; 20140029445; 20140029610; 20140029624; 20140036727; 20140036912; 20140036925; 20140056212; 20140064172; 20140081793; 20140092752; 20140092753; 20140092769; 20140092905; 20140095864; 20140105015; 20140105027; 20140105033; 20140105211; 20140108643; 20140126348; 20140126354; 20140126423; 20140126426; 20140126431; 20140126610; 20140129734; 20140129876; 20140136881; 20140161015; 20140177505; 20140219078; 20140219103; 20140219114; 20140219133; 20140222725; 20140222726; 20140222727; 20140222728; 20140222729; 20140222730; 20140222731; 20140222748; 20140222975; 20140222983; 20140222996; 20140222997; 20140222998; 20140223155; 20140245055; 20140247718; 20140247726; 20140247804; 20140254433; 20140257553; 20140257699; 20140257754; 20140269402; 20140269413; 20140269592; 20140269759; 20140281670; 20140286377; 20140293787; 20140298022; 20140304427; 20140314096; 20140328215; 20140328346; 20140330947; 20140355425; 20140372577; 20140372585; 20140376361; 20140376427; 20140379896; 20140379900; 20150002336; 20150003251; 20150003428; 20150023174; 20150023363; 20150023369; 20150026268; 20150030033; 20150032438; 20150043384; 20150043519; 20150063365; 20150071295; 20150092560; 20150110159; 20150111591; 20150139034; 20150142137; 20150155920; 20150156199; 20150180772; 20150186642; 20150186775; 20150186798; 20150186799; 20150188751; 20150188801; 20150188934; 20150188935; 20150193693; 20150193694; 20150193695; 20150193696; 20150193697; 20150195126; 20150195136; 20150195144; 20150195145; 20150195146; 20150195149; 20150195171; 20150195176; 20150195184; 20150195185; 20150195192; 20150195212; 20150195216; 20150195296; 20150200713; 20150200738; 20150200810; 20150200846; 20150207725; 20150237130; 20150242844; 20150264626; 20150264627; 20150268213; 20150285059; 20150301964; 20150310027; 20150311948; 20150318892; 20150319059; 20150319076; 20150319077; 20150319084; 20150324582; 20150326450; 20150326598; 20150326609; 20150327260; 20150332165; 20150333997; 20150334031; 20150334123; 20150341140; 20150341275; 20150350018; 20150353008; 20150372903; 20160020864; 20160020967; 20160020979; 20160020987; 20160020988; 20160020997; 20160021006; 20160021009; 20160021010; 20160021011; 20160021013; 20160021014; 20160021017; 20160021018; 20160021126; 20160021596; 20160021647; 20160026542; 20160028609; 20160028750; 20160028751; 20160028752; 20160028753; 20160028754; 20160028755; 20160028762; 20160028763; 20160028764; 20160042020; 20160044035; 20160080030; 20160132397; 20160134161; 20160134514; 20160134539; 20160142248; 20160149805; 20160149856; 20160150501; 20160156450; 20160182121; 20160197800; 20160212740; 20160224951, each of which is expressly incorporated herein by reference in its entirety.

For example, one use case provides multiple transceivers on a mountain at a geopolitical boundary. One unit sends a message out. The transmitter reads its own GPS location, and determines the appropriate communication parameters for initiating a communication, e.g., over a control channel according to a protocol. In this case, the communication passes over a geopolitical boundary. The control channel permissible for the transmitter may be different for the control channel (transmission) permissible for the receiver. However, the receiver knows its own GPS geolocation, and knows that it is within transmission range of a radio outside of the geopolitical boundary. Therefore, in addition to monitoring the channel appropriate for the region in which it lies, it also monitors the channel for the other region, without transmitting on that channel unless permissible. An acknowledgement of receipt may be sent on the acceptable control channel for the receiver, which the transmitter monitors because it also knows that it is near the border. In the initial exchange, the transmitter and receiver may negotiate mutually acceptable private communications off of the control channel.

The message may then be passed from node to node through the transceiver network, with each node determining its own GPS or other location information, and transmitting using only permitted parameters.

According to one embodiment, the transceiver device is provided with various modes implemented under different dynamically changing environmental conditions. Due to the possible latency that could result from too many transceivers in an area (like a music festival), the transceiver devices may include a mode to detect high congestion, by monitoring the control channel traffic (and/or the data channel traffic or interference), to determine whether it exceeds a certain level, which may be a predetermined or adaptive threshold. Thus, a rule, or application of a rule, which is not mandated by law, e.g., a location-based rule, may be adaptively applied, in accordance with an intelligent protocol. The database may also include temporal constraints and parameters, which are typically employed as optional preferences, rather than hard constraints.

The rules may encompass such parameters as the channel center frequency, channel bandwidth, maximum radiated power, modulation type (AM, FM, PSK, GMSK, QAM, etc.), symbol rate, retransmit protocol, interference abatement/mitigation, collision-sense behavior, etc. In a so-called “white space” environment, the rules may be more complex, and may entail listening on a channel to determine occupancy by a higher-priority user before transmitting, time of day restrictions, and other such limitations. The system may also sense radio propagation conditions, such as rain, and adjust operating parameters as may be permitted according to jurisdictional constraints to optimize performance. The present technology therefore permits a radio device to be provided which is inherently more capable that permitted by law or regulation in various jurisdictions or locations, and which is self-constrained to permissibly operate. This, in turn, means that a single device may be distributed in multiple incompatible markets, and yet avoid impermissible operation in each relevant jurisdiction.

See, en.wikipedia.org/wiki/White_spaces_(radio), U.S. Pat. Nos. 6,425,525; 6,840,442; 7,876,845; 7,881,393; 8,023,425; 8,060,017; 8,060,035; 8,060,104; 8,099,412; 8,130,141; 8,130,708; 8,155,603; 8,155,649; 8,170,577; 8,179,797; 8,194,986; 8,224,364; 8,228,861; 8,229,812; 8,250,207; 8,254,481; 8,259,830; 8,270,310; 8,270,952; 8,273,610; 8,274,996; 8,305,980; 8,321,526; 8,326,313; 8,326,958; 8,331,901; 8,351,898; 8,355,337; 8,355,862; 8,363,550; 8,364,766; 8,379,586; 8,385,916; 8,385,971; 8,391,794; 8,396,458; 8,401,478; 8,401,564; 8,406,733; 8,437,271; 8,437,363; 8,437,700; 8,441,989; 8,442,445; 8,467,312; 8,468,244; 8,473,989; 8,478,667; 8,493,931; 8,503,791; 8,514,825; 8,516,552; 8,520,979; 8,531,986; 8,532,041; 8,537,910; 8,547,872; 8,548,465; 8,553,791; 8,570,908; 8,577,406; 8,583,129; 8,583,781; 8,588,110; 8,594,061; 8,606,021; 8,629,803; 8,630,192; 8,630,611; 8,631,102; 8,635,678; 8,639,811; 8,639,935; 8,640,198; 8,643,540; 8,644,851; 8,654,721; 8,660,498; 8,666,364; 8,667,571; 8,670,493; 8,675,507; 8,688,099; 8,695,073; 8,705,527; 8,711,820; 8,711,821; 8,713,630; 8,718,797; 8,724,554; 8,730,990; 8,737,957; 8,744,476; 8,755,837; 8,768,313; 8,792,448; 8,797,908; 8,799,451; 8,805,110; 8,811,502; 8,811,903; 8,818,283; 8,824,382; 8,825,595; 8,830,863; 8,838,982; 8,839,387; 8,839,388; 8,848,608; 8,849,259; 8,855,230; 8,855,372; 8,855,712; 8,863,256; 8,867,418; 8,868,671; 8,873,853; 8,874,398; 8,879,416; 8,879,606; 8,886,162; 8,886,206; 8,897,743; 8,897,744; 8,898,079; 8,903,452; 8,903,593; 8,909,642; 8,917,209; 8,923,129; 8,923,225; 8,924,549; 8,929,877; 8,929,933; 8,938,270; 8,947,230; 8,948,445; 8,958,835; 8,971,211; 8,976,677; 8,977,274; 8,982,826; 8,989,954; 8,994,827; 9,001,693; 9,008,724; 9,014,026; 9,025,536; 9,030,446; 9,036,509; 9,037,127; 9,042,362; 9,049,686; 9,049,711; 9,052,792; 9,055,510; 9,057,606; 9,070,272; 9,083,581; 9,088,910; 9,088,995; 9,094,892; 9,104,915; 9,107,092; 9,107,137; 9,13,352; 9,116,137; 9,119,165; 9,119,214; 9,124,347; 9,129,277; 9,136,153; 9,137,739; 9,154,900; 9,159,084; 9,167,604; 9,170,625; 9,173,104; 9,176,217; 9,179,308; 9,179,315; 9,179,316; 9,191,826; 9,198,117; 9,199,653; 9,204,038; 9,204,330; 9,204,374; 9,208,384; 9,213,327; 9,215,670; 9,220,061; 9,225,782; 9,232,403; 9,232,527; 9,232,547; 9,235,975; 9,241,305; 9,246,542; 9,250,092; 9,257,030; 9,271,133; 9,277,370; 9,282,588; 9,291,712; 9,301,156; 9,304,743; 9,307,505; 9,319,968; 9,324,227; 9,326,159; 9,332,439; 9,338,789; 9,350,519; 9,351,193; 9,356,574; 9,356,738; 9,363,724; 9,367,770; 9,372,266; 9,372,477; 9,374,146; 9,378,065; 9,378,528; 9,380,009; 9,386,510; 9,391,839; 9,392,524; 9,398,599; 9,408,024; 9,408,185; 9,425,974; 9,439,036; 9,443,271; 9,451,400; 9,456,450; 9,468,007; 9,477,313; 9,490,985; 9,491,564; 9,510,302; 9,516,552; 9,516,647; 9,532,161; 9,538,388; 9,542,203; 9,565,512; 9,565,543; 9,585,025; 9,591,438; 9,600,807; 9,600,982; 9,602,971; 9,608,789; 9,609,459; 9,615,192; 9,622,253; 9,635,561; 9,639,184; 9,641,327; 9,641,957; 9,647,743; 9,648,444; 9,654,937; 9,680,538; 9,681,306; 9,681,462; 9,692,984; 9,698,981; 9,702,721; 9,706,486; 9,721,017; 9,722,660; 9,730,186; 9,736,646; 9,742,562; 9,743,281; 9,743,317; 9,749,958; 9,756,655; 9,763,121; 20020066782; 20020120728; 20030037181; 20080046738; 20080294630; 20090047916; 20090124207; 20090124208; 20090252134; 20090254572; 20090268783; 20090298522; 20100046440; 20100046842; 20100048234; 20100048242; 20100073229; 20100075704; 20100097952; 20100105332; 20100118925; 20100145900; 20100173586; 20100188975; 20100188990; 20100188991; 20100188992; 20100188993; 20100188994; 20100188995; 20100190470; 20100191575; 20100191576; 20100191604; 20100191612; 20100191613; 20100191846; 20100191847; 20100192120; 20100192170; 20100192207; 20100192212; 20100246506; 20100250497; 20100255801; 20100316033; 20110019104; 20110019652; 20110034176; 20110034204; 20110039495; 20110070838; 20110070885; 20110080882; 20110085524; 20110103437; 20110110349; 20110116487; 20110116488; 20110123028; 20110124291; 20110143761; 20110143811; 20110154199; 20110212717; 20110258214; 20110263250; 20110280447; 20110287802; 20110310840; 20110310865; 20110310866; 20110310867; 20110317019; 20120026941; 20120033621; 20120082039; 20120087279; 20120088470; 20120089845; 20120093092; 20120106428; 20120106461; 20120114249; 20120122477; 20120129301; 20120134291; 20120135767; 20120147857; 20120148068; 20120165056; 20120182180; 20120182935; 20120190404; 20120192249; 20120195206; 20120195222; 20120195223; 20120196565; 20120197792; 20120201133; 20120202510; 20120203677; 20120208496; 20120208558; 20120209750; 20120210391; 20120214441; 20120231826; 20120239479; 20120243509; 20120248595; 20120258776; 20120270583; 20120275354; 20120282942; 20120294195; 20120302275; 20130003591; 20130003613; 20130005240; 20130005299; 20130005322; 20130006729; 20130006780; 20130011062; 20130040703; 20130045710; 20130054723; 20130057434; 20130057436; 20130063301; 20130063302; 20130063307; 20130063308; 20130063613; 20130064197; 20130070605; 20130072149; 20130073464; 20130073859; 20130080607; 20130090071; 20130096998; 20130117402; 20130120188; 20130125219; 20130132578; 20130133028; 20130148642; 20130148643; 20130159074; 20130159433; 20130165134; 20130170471; 20130191213; 20130201316; 20130201847; 20130208587; 20130215795; 20130217408; 20130217440; 20130223673; 20130227659; 20130229951; 20130229996; 20130231084; 20130231121; 20130235766; 20130239194; 20130250768; 20130273968; 20130275222; 20130281108; 20130286959; 20130295894; 20130298248; 20130301569; 20130301584; 20130301870; 20130316756; 20130329620; 20130336155; 20140019117; 20140024340; 20140029600; 20140039823; 20140052555; 20140052794; 20140055300; 20140064128; 20140079043; 20140080428; 20140086081; 20140086120; 20140087778; 20140092765; 20140093005; 20140098671; 20140106763; 20140113583; 20140113649; 20140126410; 20140135032; 20140136104; 20140139422; 20140139454; 20140139486; 20140139637; 20140143678; 20140143737; 20140143784; 20140143785; 20140146804; 20140164352; 20140169686; 20140171030; 20140172576; 20140181229; 20140185559; 20140193087; 20140198687; 20140207792; 20140213300; 20140215491; 20140219566; 20140228067; 20140233412; 20140233667; 20140235230; 20140254540; 20140269845; 20140274179; 20140274184; 20140282586; 20140292580; 20140295863; 20140301327; 20140303807; 20140314003; 20140321409; 20140321571; 20140334422; 20140348023; 20140348024; 20140348083; 20140359298; 20140368381; 20150011194; 20150011970; 20150020614; 20150020615; 20150021465; 20150022337; 20150022340; 20150022351; 20150022352; 20150022356; 20150022357; 20150022675; 20150029987; 20150043338; 20150045063; 20150063214; 20150072702; 20150081349; 20150085899; 20150088910; 20150117269; 20150119101; 20150139115; 20150146709; 20150163694; 20150181087; 20150185161; 20150195414; 20150195714; 20150200882; 20150201331; 20150201333; 20150215786; 20150220994; 20150223187; 20150226854; 20150229461; 20150237550; 20150248235; 20150256245; 20150264554; 20150268205; 20150271732; 20150289089; 20150289147; 20150295629; 20150302728; 20150304797; 20150310601; 20150319700; 20150327148; 20150327328; 20150332031; 20150358525; 20150358943; 20150365285; 20150373554; 20160018799; 20160018800; 20160019780; 20160026621; 20160029430; 20160034305; 20160043783; 20160044711; 20160056927; 20160063821; 20160070276; 20160070614; 20160070920; 20160071148; 20160071183; 20160071184; 20160071219; 20160072891; 20160073356; 20160073429; 20160100283; 20160100357; 20160110085; 20160110994; 20160112821; 20160119867; 20160128075; 20160135199; 20160135204; 20160142880; 20160157187; 20160165534; 20160165630; 20160174206; 20160198350; 20160227477; 20160227478; 20160227489; 20160227569; 20160242031; 20160242194; 20160255620; 20160255645; 20160255656; 20160259062; 20160262024; 20160262025; 20160262185; 20160266939; 20160269359; 20160269533; 20160269930; 20160270090; 20160286532; 20160292276; 20160294622; 20160301238; 20160301459; 20160308917; 20160316422; 20160323259; 20160323279; 20160323711; 20160323802; 20160328023; 20160330567; 20160345192; 20160359665; 20160359777; 20160360336; 20160360382; 20160360458; 20160364634; 20160366653; 20160381565; 20160381706; 20170004208; 20170006528; 20170017636; 20170019853; 20170019863; 20170026282; 20170078400; 20170078492; 20170078826; 20170078922; 20170086281; 20170127409; 20170131758; 20170132115; 20170134653; 20170134891; 20170155490; 20170171766; 20170181204; 20170188250; 20170192958; 20170195954; 20170201889; 20170206529; 20170208474; 20170215028; 20170215073; 20170223516; 20170231009; 20170236407; 20170237623; 20170245280; 20170249491; 20170249668; 20170251339; 20170257153; 20170265189; 20170265201; and 20170265287.

According to one embodiment, the transceiver device is capable of operating in unlicensed or minimally licensed bands, and in highly regulated bands, based on a software control. If a user wishes to make use of operation in a highly regulated band, a code may be provided to permit the user to subscribe to the band. The subscription typically requires a payment to a licensee for the band, which can be a periodic (recurring) payment, a payment based on data usage, a payment based on time usage, or the like. The subscription may be prospective or retrospective; that is, a user may acquire license rights, typically in the form of a cryptographic key that unlocks the features. A subscription restriction may also be provided within the rule base, and be geographically encoded, or geography independent.

The key may be communicated over the Internet, to the application running on the smartphone or computer, or through the control channel. The key may also simply be a code that is entered, either directly into the transceiver device or into the applet which controls/communicates with it. A hardware key, also known as a “dongle” may be used to provide the authorization. Similarly, other known methods of providing and enforcing a prospective subscription may be implemented, either in the applet or control software, or in the firmware of the transceiver device, or both. In the case of a retrospective (post-paid) subscription, the user is provided with an account, and typically, a “credit limit”, such that protracted use of the services without paying is limited. The transceiver device, therefore, may have a secure non-volatile memory that monitors usage and required payments, which may be absolute or relative, e.g., tokens. The transceiver imposes a limit on the deficit or payment or tokens than can be accumulated, and will not operate in the highly regulated band after the limit is reached. Typically, the post-paid subscription is tightly coupled to a real time or near real-time accounting system. For example, in the highly regulated band, there may be a set of infrastructure base stations, with which most communications are conducted. Therefore, the base station can transact with the transceiver device immediately, to ensure compliance with the rules. As noted, the implementation may be in the firmware of a processor that controls the transceiver device, in an application program or applet that communicates with the transceiver device, within a dongle or specialized cable, or the like. Advantageously, if there is a highly regulated band available, the system may permit the control channel communications to occur on the highly regulated band, and charge premium fees for use of data channels within the highly regulated band, and otherwise permit free communications only on the “free” channels.

It is noted that the permissions and keys may be geocoded in the database, and need not be distributed as a prelude to communications. Thus, in addition to radio operational parameters, the database may store logical operational parameters, e.g., cryptographic keys.

According to another embodiment, a manufacturer may unilaterally impose control over its radios, as a form of private regulation. Thus, for example, in a multichannel or multiband radio, certain communications capabilities may be regionally reserved for premium customers, while non-premium customers are restricted from these reserved frequencies. Similarly, time multiplexing or other quality of service distinctions may be made. Further, these limitations may be not only location dependent, but load dependent, with premium users given an advantage under congested conditions, but non-premium uses suffering no impairment under low congestion conditions.

According to an embodiment, the transceiver devices operate within a proprietary band, i.e., a frequency band that is controlled by an entity and subject to use under terms and conditions imposed by that entity. In that case, there will generally be low interference on the operating frequencies, and perhaps more importantly, the protocol for operation of the transceiver devices may be engineered to follow a deterministic protocol, without significant consideration for non-cooperative devices operating on the same band. When operating in such a controlled band, cooperation and deference between transceiver devices may be enforced. In order to police usage of the band, the identification messages broadcast by each transceiver device may be filtered for authorization, either by a base station system, or by an authorization list/revocation list implemented by a distributed group of transceiver devices. If a transceiver device has an expired or invalid authorization or subscription, a base station may refuse to permit or facilitate operation, or broadcast a list of authorized/unauthorized transceiver devices which act as a filter for forwarding messages between transceiver devices in an ad hoc mode. The authorization may also be communicated through the Internet by way of smartphones or computers which interface with the transceiver devices. The administration of usage in this case may be independent of geopolitical boundary, but may be arbitrarily geofenced or geographically limited. As can be seen, in the case of regional licenses, each licensor may impose different restrictions on use of its licensed channels, which can all be implemented according to the geocoded rules.

According to one embodiment, all control over the communications is automatic, without user intervention. In another embodiment, a user interface is provided to permit user control and selection of operating modes, within geographically proscribed constraints. The geolocation system, e.g., GPS acts as a filter for the full range of operating parameters, to only provide access to the modes which are jurisdictionally allowed. Thus, both “auto-tuning” and “filtering” are possible.

The user/machine interface device, e.g., an Apple iPhone 8/iOS, Android 2.0-7, Linux or proprietary operating system, is preferably controlled through an “app”, that is, a software program that generates a user interface and employs operating system facilities for controlling the hardware. The app in this case may provide a communication port for use by the operating system, and therefore can generally communicate data, though compliance with various FCC limits may require restricted usage, especially with respect to connection to the telephone network. Likewise, received data may also be restricted, e.g., retransmission. Alternately, the communications to the transceiver module may present as a service, and therefore available to other apps executing on the user/machine interface device. The transceiver device may be presented to the host as a generic network communication device, for example if broadband communication is possible, or if not, present as a limited communication device to avoid attempts at mass network data transfers. This configuration may also be automatically defined, in part, by the georeferenced database.

The communication device may itself be, or may be connected to, an “internet of things” (IoT) device. See, U.S. Pat. Nos. 6,625,651; 6,732,167; 6,813,278; 6,836,803; 6,961,778; 8,238,905; 8,458,315; 8,583,109; 8,630,177; 8,660,600; 8,743,768; 8,761,285; 8,800,010; 8,874,788; 8,879,613; 8,891,588; 8,917,593; 8,923,186; 8,934,366; 8,965,845; 8,996,666; 9,000,896; 9,026,554; 9,026,840; 9,026,841; 9,059,929; 9,077,772; 9,083,627; 9,084,281; 9,087,215; 9,087,216; 9,088,983; 9,094,835; 9,094,873; 9,094,999; 9,118,539; 9,129,133; 9,131,266; 9,135,208; 9,154,966; 9,160,760; 9,166,908; 9,167,592; 9,172,613; 9,176,832; 9,185,641; 9,204,131; 9,225,616; 9,230,104; 9,231,758; 9,231,965; 9,258,765; 9,270,584; 9,280,747; 9,282,059; 9,286,473; 9,292,832; 9,294,476; 9,294,488; 9,306,841; 9,312,919; 9,317,378; 9,319,332; 9,325,468; 9,338,065; 9,338,716; 9,342,391; 9,350,635; 9,351,162; 9,356,875; 9,357,417; 9,358,940; 9,361,481; 9,369,351; 9,369,406; 9,374,281; 9,384,075; 9,385,933; 9,386,004; 9,397,836; 9,398,035; 9,400,943; 9,401,863; 9,407,542; 9,407,646; 20030074463; 20100234061; 20110176528; 20120011360; 20120143977; 20120224694; 20120250669; 20130159479; 20130159486; 20130159548; 20130159550; 20130219046; 20130223218; 20130259010; 20130260820; 20130260821; 20130272283; 20130273965; 20130283347; 20130283360; 20130295990; 20130324112; 20130324113; 20140029432; 20140029445; 20140029610; 20140036908; 20140038526; 20140051426; 20140092753; 20140126348; 20140126423; 20140126431; 20140129734; 20140195807; 20140222730; 20140222975; 20140244768; 20140244834; 20140244997; 20140269413; 20140269534; 20140281670; 20140310243; 20140314096; 20140337850; 20140359131; 20150007273; 20150019432; 20150019717; 20150023174; 20150023183; 20150023186; 20150023205; 20150023336; 20150023363; 20150023369; 20150026268; 20150026317; 20150026779; 20150043384; 20150043519; 20150063365; 20150067329; 20150071052; 20150071216; 20150071295; 20150074195; 20150081904; 20150089081; 20150113621; 20150121470; 20150127733; 20150128205; 20150128284; 20150128285; 20150128287; 20150130641; 20150130957; 20150134481; 20150135277; 20150138977; 20150148989; 20150149042; 20150156266; 20150180772; 20150180800; 20150185311; 20150185713; 20150186642; 20150188751; 20150188934; 20150188935; 20150188949; 20150193693; 20150193694; 20150193695; 20150193696; 20150193697; 20150195145; 20150195146; 20150195216; 20150195296; 20150195670; 20150200713; 20150200810; 20150229713; 20150235329; 20150237071; 20150244828; 20150249642; 20150249672; 20150256337; 20150256385; 20150261876; 20150264544; 20150264626; 20150264627; 20150269383; 20150311948; 20150314454; 20150319038; 20150319076; 20150324582; 20150326450; 20150326598; 20150326609; 20150327261; 20150332165; 20150333997; 20150334123; 20150339686; 20150339917; 20150350008; 20150350018; 20150358332; 20150365473; 20150379303; 20150382399; 20160004871; 20160006500; 20160006673; 20160006837; 20160007398; 20160014078; 20160014154; 20160019497; 20160020864; 20160020967; 20160020979; 20160020987; 20160020988; 20160020997; 20160021006; 20160021010; 20160021011; 20160021013; 20160021014; 20160021017; 20160021018; 20160021126; 20160021169; 20160021596; 20160026542; 20160028605; 20160028609; 20160028750; 20160028751; 20160028752; 20160028753; 20160028754; 20160028755; 20160028762; 20160028763; 20160028764; 20160036819; 20160036908; 20160037436; 20160041534; 20160044531; 20160052798; 20160064955; 20160070611; 20160072832; 20160073482; 20160088424; 20160088550; 20160094395; 20160100350; 20160105402; 20160110728; 20160112262; 20160119184; 20160119403; 20160119931; 20160127539; 20160127540; 20160127541; 20160127548; 20160127549; 20160127562; 20160127566; 20160127567; 20160127569; 20160127808; 20160128043; 20160132397; 20160134161; 20160134419; 20160134468; 20160134514; 20160134539; 20160135241; 20160142248; 20160149805; 20160149836; 20160149856; 20160150501; 20160151917; 20160162654; 20160164730; 20160164831; 20160165570; 20160171979; 20160173318; 20160178379; 20160180679; 20160182170; 20160182531; 20160188350; 20160191350; 20160191716; 20160192302; 20160193732; 20160195602; 20160197800; 20160199977; 20160203490; 20160204992; 20160210297; 20160210832; 20160216130; 20160217384; 20160217387; 20160217388; 20160219024, each of which is expressly incorporated herein by reference in its entirety.

The technology preferably provides a hardware and software bundle that can enable computers and mobile phones to communicate data packets with a relatively small data payload, without relying on the Internet or the central cellular network infrastructure. This may be referred to as user-to-user communications (U2U), point-to-point (P2P), vehicle to infrastructure (V2I) or vehicle to vehicle (V2V). Computers and mobile phones enable users to send much more than text messages. For example, GPS coordinates, multimedia from the situation, accelerometer and other sensor data can all be sent over a decentralized network, enabling enhanced communication and situation response when the central grid is unavailable.

The present technology provides peer to peer transceiver devices which enable an extended range of much greater than 100 m, for example up to several km or more. They may be configured to operate in an unlicensed radio band using narrow channels, in a public band that may be lightly regulated, or as broadband communicators. Preferably, in any band in which they operate which has standardized protocols, the radio is compatible with the various protocols (multiprotocol), and where different protocols are preferred or mandated on a geographic basis, the device is controlled to employ those preferences or mandates.

The system may implement a band management protocol to gracefully select the communication channel to minimize interference, provide retransmission as appropriate, and to overall provide the optimum performance of the system, including establishing a collision-sensing and/or or token passing protocol. Preferably, channel assignments and communication system control employs a control channel, while communications themselves employs other channels. As available, the control channel may also be used to communicate data.

A memory in the device may comprise a plurality of storage locations that are addressable by the microprocessor(s) and the network interfaces for storing software programs and data structures associated with the embodiments described herein. The microprocessor may comprise necessary elements or logic adapted to execute the software programs and manipulate the data structures, such as a routing table/cache, and a topology configuration. An operating system may optionally be provided, which interacts with the hardware and provide application programming interfaces, though in simple embodiments, an operating system is not required. For example, an embedded Linux, such as BusyBox, may be provided, which provides various functions and extensible software interfaces, portions of which are typically resident in memory and executed by the microprocessor(s). The software, including the optional operating system if present, functionally organizes the node by, inter alia, invoking network operations in support of software processes and/or services executing on the device. These software processes and/or services may comprise routing services, disjoint path process, and a timer. It will be apparent to those skilled in the art that various processor and memory types, including computer-readable media, may be used to store and execute program instructions pertaining to the techniques described herein.

In one embodiment, the same information is transmitted concurrently on multiple channels in multiple bands; in other cases, different information may be communicated in the different bands. Each band may have different location-dependent licensing issues. Preferably, the processor has a database of the various restrictions, and implements these restrictions automatically. In some cases, this may require location information, and in such case, the transceiver device may comprise a GPS (global positioning system) receiver device. For example, in the “whitespace” vacated by prior incumbent analog television broadcasters, unlicensed use is subject to geographic restrictions. Use of these bands is subject to regulation in the US under parts 90, 91 and 95 of the FCC rules, 47 C.F.R., which are expressly incorporated herein by reference.

In a preferred embodiment, the hardware is relatively compact and inexpensive. For example, the Analog Devices ADF7021-N provides a narrowband transceiver IC which supports digital communications in various bands, including the GMRS, FRS and MURS bands. See Analog Devices Application Note AN1285. Baseband radio devices are also available, e.g., CMX882 (CML Micro), which is a full-function half-duplex audio and signaling processor IC for FRS and PMR446 type facilities. For advanced and enhanced radio operation the CMX882 embodies a 1200/2400 bps free-format and formatable packet data FFSK/MSK modem (compatible with NMEA 0183) for Global Positioning by Satellite (GPS) operations. In the Rx path a 1200/2400 bps data packet decoder with automatic bit-rate recognition, 16-bit frame-sync detector, error correction, data de-scrambling and packet disassembly is available. The CMX838 and CMX7031/CMX7041 also supports communications over FRS and MURS. See also, CMX7131 and CMX7141 (Digital PMR (DPMR) Processors), CMX7161 (TDMA Digital Radio Processor), CMX7861 (Programmable Baseband Interface), CMX8341 (Dual-mode Analogue PMR and Digital PMR (dPMR®) Baseband Processor), CMX981 (Advanced Digital Radio Baseband Processor). In another embodiment, a 928 MHz ISM band radio is employed.

A preferred embodiment of the technology provides a self-contained device having a local, short range wireless (e.g., Bluetooth or WiFi) or wired link (USB 2.0 or 3.0), which communicates a data stream, as well as high level control information, such as destination, mode (point-to-point communication, multicast, broadcast, emergency, etc.), and other information. The device typically includes a battery, for example to power the device even in event of an emergency. The device includes a long range (e.g., up to 8-20 miles) transceiver and associated antenna and/or antenna coupler. A modem circuit is provided to convert a data stream into a modulated radio frequency signal, and to demodulate a received modulated radio frequency signal into a data stream. A processor is provided to create and receive the data stream, as well as provide low level control to the modem circuit and radio frequency transmitter, such as to autonomously communicate over a control channel, packetize the data to include identifying, routing and control headers. The device may also include one or more sensors, such as GPS, temperature, pressure, seismology (vibration), movement, etc. Typically, the device will have a simple user interface, such as an on-off switch, and micro-USB data/charging port. The radio may also be a digital implementation with minimized analog components.

One of the channels in the band at a location may be designated as a control channel. On this channel, each device listens for data packets that reference it, either individually or as part of a defined group, or in cases of multihop mesh network, packets which the respective node could forward. The device also maintains a table of all nodes in communication range and/or a full or partial history of prior contacts, based on a proactive (transmission of information before a need arises) and/or reactive (transmission of information on an as-needed basis) protocol. The device may broadcast a packet periodically to other devices, to help establish their respective tables, or seek to establish a network at the time a communication is required. The system may conserve power by powering down for most of the time, and activating the radio functions in a predetermined and predictable window of time. For example, if GPS is provided, a common synchronized window of 1 millisecond per 10 seconds may be provided for signaling, to provide a low duty cycle quiescent state. Advantageously, the time windows may be geocoded, so that a radio on a geographic boundary can successively monitor different control channels dependent on location, in a time-multiplexed manner. Other types of synchronization are possible, such as a broadcast time signal with micropower receiver. If a signal is present during a predetermined window, the radio remains on to listen for the entire message or set of messages. This permits a low duty cycle, and therefore reduced power consumption.

The processor within the device controls all communications on the control channel, and typically does so autonomously, without express control or intervention by the control signals received through the short range communication link, e.g., from the smartphone app. If communications on the preferred control channel are subject to interference, a secondary control channel may be used. In some cases, a separate control channel or algorithm for switching to other control channels may be provided for each communication band. These various options may be controlled based on the geo-based rule set.

Various known signaling and communication protocols may be employed, see, U.S. Pat. No. 9,756,549.

A collision sensing technology may also be provided, with random delay retransmit in case of collision, and a confirmation packet sent to confirm receipt. In such a scenario, predetermined timeslots would be disrupted, but in cases of interference, such presumption of regularity is violated in any case. In some cases, the confirmation packet may include an embedded response, such as routing information. The basic protocol may include not only error detection and correction encoding, but also redundant transmission, over time, especially when impaired channel conditions are detected. That is, the data communications and control channel communications may include an adaptive protocol which optimizes the throughput with respect to channel conditions, communications community, and/or network topology, and therefore adopt different strategies for balancing efficient channel usage and reliability. It is generally preferred that the control channel have a range and reliability in excess of normal communication channels, and thus may operate at a higher power, lower modulation rate (in order to provide a more robust signal), or with enhanced error detection and correction, and perhaps redundancy.

The power supply may comprise a rechargeable battery, and a battery charging control circuit. The battery charging circuit may comprise an inductively coupled battery charger. The communication port may comprise at least one of a low energy Bluetooth 4.0 communication port, a universal serial bus port, a Zigbee communication port (IEEE 802.15.4), a Z-wave communication port, a WiFi communication port (IEEE 802.11x), and an Insteon communication port. The at least one processor may have an associated non-volatile reprogrammable memory, and wherein the protocol is defined in accordance with instructions stored in the non-volatile reprogrammable memory.

The at least one processor may be associated with program instructions (and a georeferenced database) which enforce compliance with local geopolitical jurisdictions' radio-frequency regulatory rules (ex. FCC in the US, IC in Canada, etc.) e.g., for use of the radio frequency control channel and the data communication channel, when in jurisdictions that apply such regulations, and otherwise apply geo-applicable restrictions as may be appropriate. Rule sets from private agreements may apply to the RF behavior, however those would typically be applied only after applying the geopolitical rulesets. For example, in the United States, unlicensed operation is allowed at 1 W on the 902-928 Mhz ISM bands, with a maximum airtime of X milliseconds per channel—while in Europe a frequency band with a similar use intent is actually located at 869 Mhz but is restricted to 0.5 W and maximum airtime is restricted to Y milliseconds per channel with an aggregate limit of no more than Z seconds of transmission by a single user in R timeframe. As an example of private rule sets, a licensor of different frequencies spread out over a region may only make certain operational RF modes available to their customers depending on where they happen to be.

The at least one automated processor may be provided with an emergency mode of operation which communicates autonomously without continued dependence on receipt the first digital data. Likewise, the at least one automated processor may be configured to detect emergency mode transmissions from the corresponding radio frequency digital communication system, and to produce an output without dependence on receipt of the at least one radio frequency digital communication system identifier. In an emergency mode, relaxed compliance with rules may be permitted.

The communication device may have an electrically reprogrammable (flash) memory to store packets before transmission, received packets, address and targeting information, and firmware providing instructions including protocol definition for the automated processor in the communication device. The firmware for the communication device may be updatable through the short-range communication link, e.g., Bluetooth, or through the wired USB port. An internal JTAG communication port may also be provided for diagnostics and setup. A security protocol may be employed to ensure that only factory authorized firmware may be loaded, in a manner similar to restrictions on cellular phone firmware.

The geocoded rules may be provided in the communication device, or in the host (user interface) device. Similarly, the geolocation system may be provided in the communication device, or in the host (user interface) device. These features need not be located in the same device, and may be located in both devices.

According to one option, the radio can freely set all its parameters, with no predetermined configurations. The host device then communicates with the radio to define the correct mode of operation. According to a second option, the radio stores sets of predetermined communication schemes, which are then implemented based on a location code. The second option is more compatible with stand-alone operation. Preferable, in either case, when the geolocation system is not provided within the communication device, a memory stores the last set of permissible communication parameters, and thus some stand-alone operating capability is maintained. When reconnected to the host, the location code, and operating parameters, are updated as appropriate.

The app, which executes within the host device, as part of a smartphone or computational environment, can download the latest firmware and rules, and automatically update the communication device, so that all communication devices support interoperable protocols, and the number of versions of the protocol that need to be concurrently supported is limited. In some cases, there may be alternate firmware and associated protocols, which may be selected by a user according to need and environment. For example, a GPS derived location in the smartphone can inform the “app” which protocol is most appropriate and permissible for the operating environment (e.g., city, suburban, rural, mountain, ocean, lake, weather effects, emergency conditions, user density, etc.). For transceivers in locations where multiple modes are legal and allowed by all involved parties (at times commercial contracts), the phone may use the geographic information to filter out unauthorized modes and only present the allowable modes to the user so as to reduce the chance of user error or purposeful non-compliance. In order to limit the required storage for various protocols within the communication device, these may be loaded as needed from the smartphone.

The communication device may be part of, or linked to, the “Internet of Things” (IoT). Typically, in an IoT implementation, the goal is to provide communications for automated devices. According to one embodiment, the communication device may be the same hardware as described in prior embodiments. However, in that case, the firmware may provide a different communication protocol and other aspects of operation, and instead of a smartphone-type control device, the data source or sink may or may not have a human user interface, and typically controls the data communications in an autonomous manner. The system may incorporate energy harvesting, especially when transmissions are bursty with low duty cycle, i.e., less than 0.1%, with a 2-watt output (average 2 mW).

The IoT control device or smartphone can, in addition to communicating data and address information, can also manage power (read battery level, control transmission power, manage duty cycles and listening periods, etc.). Based on estimated power remaining and predicted charging cycles, the system can optimize consumption and usage to achieve continuous operation. The control device can also warn the user through the user interface when a recharge cycle is required. Geocoded rules may also take into account power supply restrictions (e.g., battery), and impose geocoded rules that are independent of external mandate.

It is therefore an object to provide a transceiver system, comprising: a software-defined parameter radio transceiver, having software control over at least a frequency channel of operation and output power; a processor, configured to establish parameters of operation for the software-defined parameter radio; a geolocation determining system, configured to supply geolocation information for the software-defined parameter radio transceiver; a database, containing geolocation indexed parameters defining constraints on operation of the software-defined parameter radio transceiver; and computer executable code, which is adapted to control the processor to constrain operation of the software-defined parameter radio transceiver selectively in dependence on the geolocation indexed parameters.

The software-defined parameter radio transceiver, the processor, geolocation determining system, and the database, may be provided within a common housing. The software-defined parameter radio transceiver and the geolocation determining system may be provided within respectively different housings. The software-defined parameter radio transceiver and the database may be provided within respectively different housings.

The software-defined parameter radio transceiver may receive the geolocation indexed parameters from the database through a wireless communication link.

A further object provides a method of operating a transceiver, comprising: providing a software-defined parameter radio transceiver, having software control over at least a frequency channel of operation and output power; establishing parameters of operation for the software-defined parameter radio, in dependence on a geolocation determined by a geolocation determining system, and a database containing geolocation indexed parameters defining constraints on operation of the software-defined parameter radio transceiver; and controlling the software-defined parameter radio transceiver to remain within the geolocation indexed parameters defining constraints on operation selectively in dependence on the geolocation indexed parameters.

The geolocation indexed parameters may be received from the database to the software-defined parameter radio transceiver through a wireless communication link.

The geolocation indexed parameters defining constraints on operation may comprise radio frequency transmission limits mandated by law or regulation, legal license restrictions on radio frequency transmission, commercial license restrictions on radio frequency transmission, and/or quality of service tiers, wherein the processor is further configured to determine an account status for eligibility for a respective quality of service tier.

The method may further comprise determining a user authorization, such as a license or service level, and the geolocation indexed parameters are further dependent on the user authorization. Therefore, the system and method may automatically limit operation or force compliance to the scope of a license or user-based restriction. The system and method may further provide for local upgrade of service level or authorization, which be communicated to a remote server for authentication, billing or processing through a cellular network, or through the ad hoc network.

A further object provides a transceiver system, comprising: a software-defined radio transceiver, having software control over at least an operating frequency and output power; a processor, configured to provide the software control over operation of the software-defined radio transceiver; a context determining system, configured to detect a context of operation of the software-defined radio transceiver; and a computer readable memory, configured to store non-transitory instructions executable by the processor to provide the software control, wherein the at least an operating frequency and power are selectively dependent on the determined context. The software control may further control a modulation type for data communications, and the software control defines the modulation type dependent on the context. The software-defined radio transceiver may be contained in a separate housing from the processor and/or the context determining system, and may have an autonomous mode of operation independent of the processor and/or the context determining system. The autonomous mode may be a default mode or a last-specified mode, or may be determined based on analysis of received radio signals received by the software-defined radio transceiver

The software-defined radio transceiver may be an ad hoc radio transceiver, and may be configured to transmit a message through a plurality of transceiver systems, each with a distinct context, comprising a multihop communication path having at least two different frequencies.

Further details of these and other embodiments are presented below.

### BRIEF DESCRIPTION OF THE DRAWINGS

The present disclosure will be more readily understood from the detailed description of exemplary embodiments presented below considered in conjunction with the attached drawings, of which:

FIG. 1 is a block diagram of a pair of communication devices and associated host/user interface devices according to the present invention.

FIG. 2 is a diagram of a communication device, having optional GPS capability.

FIG. 3 is a block diagram of a host/user interface device linked to a communication device.

It is to be understood that the attached drawings are for purposes of illustrating the concepts of the invention.

### DETAILED DESCRIPTION OF THE PREFERRED EMBODIMENTS

Software packages can be added to users' existing computers and mobile phones and enable them to transmit small data packages (text, GPS coordinates, sensor data, asynchronous voice, multimedia, or any other digital data hereafter referred to as “messages”). A transceiver module is further provided to receive the small data packages (packets) to directly communicate them to each other through a direct connection or indirectly through a mesh network (multihop network or multihop ad hoc network), without reliance on external infrastructure.

According to a preferred embodiment, an external transceiver is provided which can wirelessly communicate with a smartphone or tablet device, or other computational platform, and provides enhanced communication features.

A smartphone, tablet, or computer provides a user interface, and sophisticated programmability, while the external communication device is typically provided with a minimal user interface, minimally sufficient processing capability.

The communication device typically employs a high integration transceiver module which is capable of a plurality of communication modes in a plurality of channels.

One available radio integrated circuit is the ADF7021-N, which implements a high performance, low power, narrow-band transceiver which has IF filter bandwidths of 9 kHz, 13.5 kHz, and 18.5 kHz, making it suited to worldwide narrowband standards and particularly those that stipulate 12.5 kHz channel separation. It is designed to operate in the narrow-band, license-free ISM bands and in the licensed bands with frequency ranges of 80 MHz to 650 MHz and 842 MHz to 916 MHz. The device has both Gaussian and raised cosine transmit data filtering options to improve spectral efficiency for narrow-band applications. It is suitable for circuit applications targeted at the Japanese ARIB STD-T67, the European ETSI EN 300 220, the Korean short range device regulations, the Chinese short range device regulations, and the North American FCC Part 15, Part 90, and Part 95 regulatory standards. The on-chip FSK modulation and data filtering options allows flexibility in choice of modulation schemes while meeting the tight spectral efficiency requirements. The ADF7021-N also supports protocols that dynamically switch among 2FSK, 3FSK, and 4FSK. The transmit section contains two voltage controlled oscillators (VCOs) and a low noise fractional-N PLL. The dual VCO design allows dual-band operation. The frequency-agile PLL allows the ADF7021-N to be used in frequency-hopping, spread spectrum (FHSS) systems. The transmitter output power is programmable in 63 steps from −16 dBm to +13 dBm and has an automatic power ramp control. The transceiver RF frequency, channel spacing, and modulation are programmable using a 3-wire serial interface. Thus, the present technology can set the permissible operating parameters for the radio integrated circuit from among the full range available within the implementation.

Another radio integrated circuit is the SI4464 from Silicon Labs, www.silabs.com/documents/public/data-sheets/Si4464-63-61-60.pdf, which is a high-performance, low-current transceiver covering the sub-GHz frequency bands from 119 to 960 MHz. The Si4464 offers frequency coverage in a number of major bands, including non-standard frequencies or licensed frequency bands, and includes optimal phase noise, blocking, and selectivity performance for narrow band and licensed band applications, such as FCC Part90 and 169 MHz wireless Mbus. The 60 dB adjacent channel selectivity with 12.5 kHz channel. The Si4464 offers output power of up to +20 dBm, providing a link budget of 146 dB allowing extended ranges and highly robust communication links. The Si4464 can achieve up to +27 dBm output power with built-in ramping control of a low-cost external FET. The devices can meet worldwide regulatory standards: FCC, ETSI, and ARIB, and is designed to be compliant with 802.15.4g and WMbus smart metering standards.

Error-correction, as discussed above, may be implemented within the transceiver device, or in some cases within the smartphone or computer.

In many cases, it is desirable to communicate location coordinates. In some cases, the transceiver device includes a GPS receiver, and thus can supply this information intrinsically. In other cases, the smartphone or computing device supplies this information, based on GPS, triangulation, hard encoded location, or the like. The receiving computer or phone could use the coordinates to display sender's location on Google® Maps or in a device proximal display (display showing location relative to own GPS coordinates). Further, in mesh networks, location information may be used to route packets toward their destination.

A display may be provided to the user through the app on the smartphone or computing device showing the location of the device, and the location of devices in which it is in communication. At times users may be connected to the primary cellular networks which can provide positional information as well, and they may use this information as well on the transceiver device network—some users may do this for privacy reasons even if regular services are available.

An emergency mode may be provided, in which transceiver devices have the ability to broadcast with overpower or upgraded protocols (like increase data-rate and bandwidth) on emergency frequencies as dictated by the geopolitical regulations or private agreements.

According to one embodiment, the app provides a speech input, that for example includes voice communications as an option, speech-to-text functionality or a speech-to-phoneme code functionality. The text or codes are communicated to the recipient, where a text-to-speech or phoneme-to-speech converter can resynthesize speech. According to a further embodiment, a microphone or audio input port is provided to permit analog voice communications over the radio. In some cases, the internal processor of the communication device is capable of performing the phoneme-based audio compression and decompression, and therefore a simple microphone user interface is possible. Note that for audio-to-audio communications, accuracy of phoneme recognition is not required, since the goal is matching the acoustic properties of the received sounds at the transmitter to the reproduced sounds at the receiver. However, speech recognition for control of the device may also be implemented, which does require some objective accuracy for good results.

The transceiver device, where connected to the self-organizing network and (through the short range link to the smartphone or computing device) another network such as the Internet, may act as a network bridge. This transceiver device bridge may be for direct communications or for mesh network communications, as a termination from, or origination into the self-organizing network.

A computer system is provided, in accordance with one example, having a microprocessor controlled in accordance with a set of instructions stored in a non-transitory computer readable medium, such as flash memory. The computing system may include a set of instructions for causing the machine to perform any one or more of the methodologies discussed herein. In alternative examples, the machine may be connected (e.g., networked) to other machines in a Local Area Network (LAN), an intranet, an extranet, or the Internet. The machine may operate in the capacity of a server or a client machine in a client-server network environment, or as a peer machine in a peer-to-peer (or distributed) network environment. The machine may be a personal computer (PC), a tablet PC, a set-top box (STB), a Personal Digital Assistant (PDA), a cellular telephone, a web appliance, a server, a network router, switch or bridge, or any machine capable of executing a set of instructions (sequential or otherwise) that specify actions to be taken by that machine. Further, while a single machine is illustrated, the term “machine” shall also be taken to include any collection of machines (e.g., computers) that individually or jointly execute a set (or multiple sets) of instructions to perform any one or more of the methodologies discussed herein. The computer system includes a processing device, a main memory (e.g., read-only memory (ROM), flash memory, dynamic random access memory (DRAM) such as synchronous DRAM (SDRAM), etc.), a static memory (e.g., flash memory, static random access memory (SRAM), etc.), and a secondary memory (e.g., a data storage device), which communicate with each other via a bus. The processing device represents one or more general-purpose processing devices such as a microprocessor, central processing unit, or the like. More particularly, the processing device may be a complex instruction set computing (CISC) microprocessor, reduced instruction set computing (RISC) microprocessor, very long instruction word (VLIW) microprocessor, processor implementing other instruction sets, or processors implementing a combination of instruction sets. The processing device may also be one or more special-purpose processing devices such as an application specific integrated circuit (ASIC), a field programmable gate array (FPGA), a digital signal processor (DSP), network processor, or the like. The processing device is configured to execute the operations for private point-to-point communication between computing devices for performing steps discussed herein. The computer system may further include a network interface device. The network interface device may be in communication with a network. The computer system also may include a visual display unit e.g., a liquid crystal display (LCD)), a touch screen, an alphanumeric input device (e.g., a keyboard), a graphic manipulation control device (e.g., a mouse), a sensor input (e.g., a microphone) and a signal generation device (e.g., a speaker).

The secondary memory may include a computer-readable storage medium (or more specifically a non-transitory computer-readable storage medium) on which is stored one or more sets of instructions (e.g., instructions executed by private point-to-point communication between computing devices) for the computer system representing any one or more of the methodologies or functions described herein. The instructions for the computer system may also reside, completely or at least partially, within the main memory and/or within the processing device during execution thereof by the computer system, the main memory and the processing device also constituting computer-readable storage media. The instructions for the computer system may further be transmitted or received over a network via the network interface device. While the computer-readable storage medium is shown in an example to be a single medium, the term “computer-readable storage medium” should be taken to include a single medium or multiple media (e.g., a centralized or distributed database, and/or associated caches and servers) that store the one or more sets of instructions. The term “computer-readable storage medium” shall also be taken to include any medium that is capable of storing or encoding a set of instructions for execution by the machine that cause the machine to perform any one or more of the methodologies of the disclosure. The term “computer-readable storage medium” shall accordingly be taken to include, but not be limited to, solid-state memories, and optical and magnetic media. The disclosure also relates to an apparatus for performing the operations herein. This apparatus may be specially constructed for the required purposes, or it may be a general purpose computer system selectively programmed by a computer program stored in the computer system. Such a computer program may be stored in a computer readable storage medium, such as, but not limited to, any type of disk including optical disks, CD-ROMs, and magnetic-optical disks, read-only memories (ROMs), random access memories (RAMs), EPROMs, EEPROMs, magnetic disk storage media, optical storage media, flash memory devices, other type of machine-accessible storage media, or any type of media suitable for storing electronic instructions, each coupled to a computer system bus.

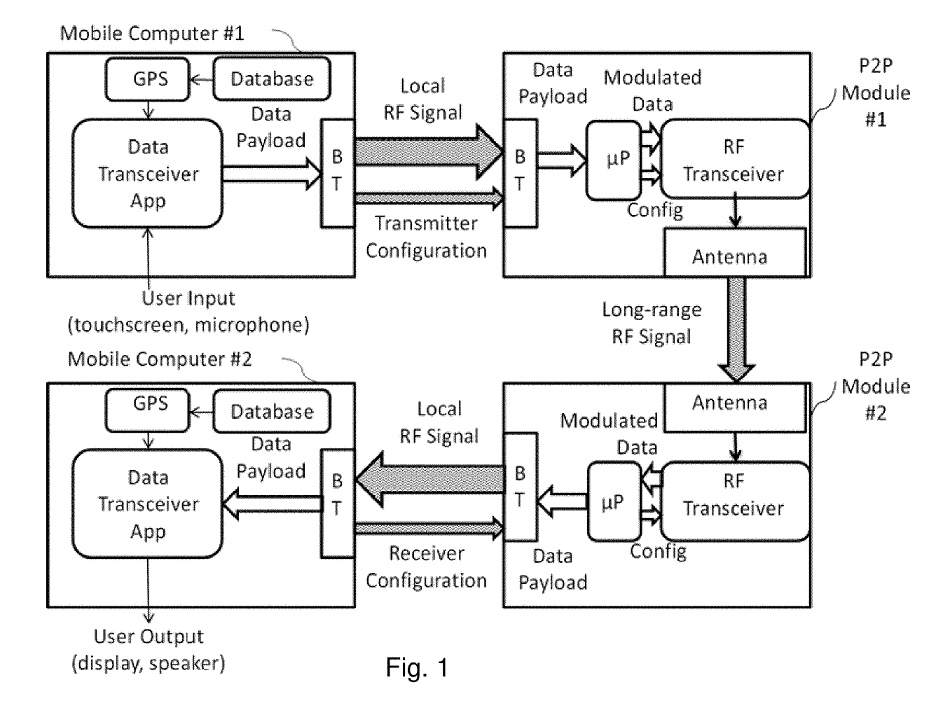

FIG. 1 shows a pair of systems in communication. Each system includes a mobile computer and a “P2P” module. The mobile computer, which may be a smartphone, provides a user interface which can acquire data and control information from a user. The mobile computer executes an “app”, or a limited function program for controlling the P2P device. The app accesses a GPS device internal to the mobile computer to obtain geolocation data, and based on the geolocation data, performs a database lookup for a configuration file, or constraints on radio operation or acceptable parameters. The user interface also defines a message or communication at the transmitter, and outputs a received message or communication at the receiver. In some cases, the communication includes GPS data. At the transmitter, the message and the transmitter configuration data is communicated to the P2P module over a Bluetooth link. A microprocessor in the P2P module accepts the transmitter configuration data to control the RF transceiver. In some cases, a parameter database file is provided within the P2P module, and the mobile computer merely passes the location to the P2P module. In other cases, the P2P module includes its own GPS, and does not require this information from the mobile computer. Under the constraints of the georeferenced parameters, the message is transmitted.

At the receiver, the respective mobile computer provisions the receive to accept communications dependent on the acceptable communications within the geographic region. In cases where the geographic region is close to a boundary with different acceptable parameters, the receiver may scan or sample transmissions of the different acceptable types. The received data is passed to the mobile computer through the Bluetooth link at the receiver and presented through the user interface or otherwise processed by the app.

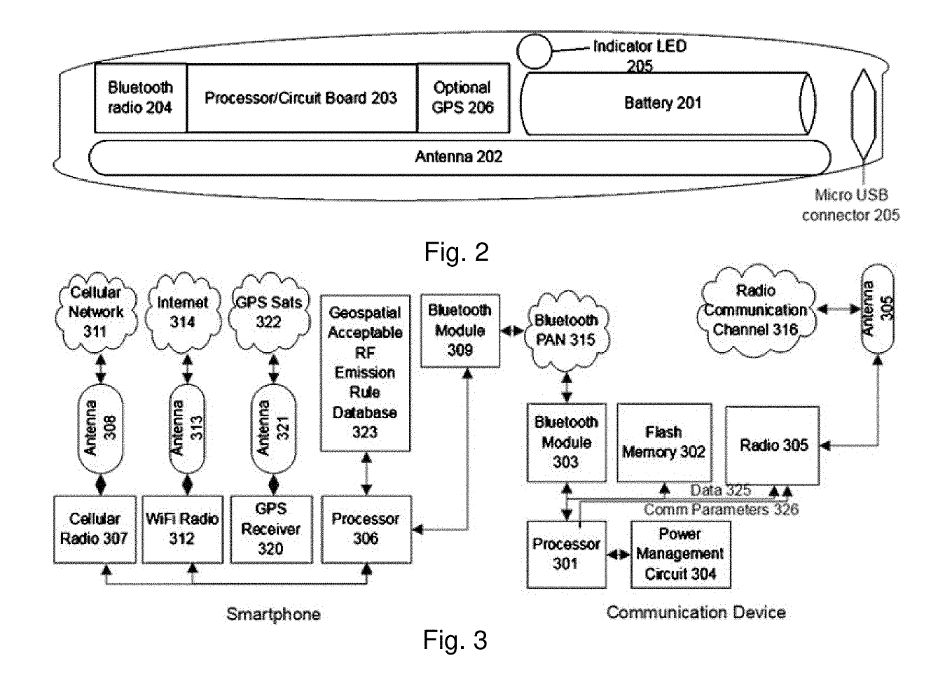

FIG. 2 shows a schematic diagram of a P2P module. This includes a Bluetooth radio 204, a processor/circuit board 203 (including processor, memory, etc.) and optional GPS 206 module. A simplified user interface is provided, for example having an on-off switch (not shown) and a multicolor indicator LED. A rechargeable battery 201, e.g., a standard type 3.7 V, 2200 mAH cylindrical cell provides power. A micro-USB connector 205 provides wired data connectivity and power to recharge the battery.

FIG. 3 shows a block diagram of the system. A smartphone (or standard type) includes a processor 306, cellular radio 307 (with an antenna 308 that interfaces with a cellular network 311), a WiFi radio 312 (with an antenna 313 that interfaces with a WiFi network to the Internet 314), a GPS receiver 320 (with an antenna 321 that receives signals from GPS satellites 322), and a Bluetooth radio module 309 that communicates with a Bluetooth PAN 315. The processor 306 accepts geolocation information from the GPS receiver 320, and performs a lookup in a geospatial acceptable RF emission rule database 323, which provides parameters for acceptable operation of a transmitter. The parameters may either be a filter for a range of acceptable parameters, or a predetermined set of operating parameters.

The communication device receives a communication of the message to be transmitted and the parameters through the Bluetooth PAN from the smartphone, through Bluetooth module 303, which is processed by processor 301. The processor 301 receives information from, flash memory 302, which for example stores the operational firmware. A volatile memory (not shown) may be embedded in the processor 301. A power management circuit 304 provides power to the processor 301, etc. The processor 301 provides signals to the radio 305 which define the mode of operation, which then transmits a signal through antenna 305, on the radio communication channel 316.

To receive a signal, the message processing pathway is inverted, though the parameters for controlling the radio are still controlled by the GPS receiver in the smartphone.

It is to be understood that the above description is intended to be illustrative, and not restrictive. Many other examples will be apparent to those of skill in the art upon reading and understanding the above description. Although the disclosure has been described with reference to specific examples, it will be recognized that the disclosure is not limited to the examples described, but can be practiced with modification and alteration within the spirit and scope of the appended claims. Accordingly, the specification and drawings are to be regarded in an illustrative sense rather than a restrictive sense. The scope of the disclosure should, therefore, be determined with reference to the appended claims, along with the full scope of equivalents to which such claims are entitled.

What is claimed is:

1. A transceiver system, comprising:
a software-defined parameter radio transceiver, having software control over at least a frequency channel of operation and output power;
a processor, configured to establish parameters of operation for the software-defined parameter radio;
a geolocation determining system, configured to supply geolocation information for the software-defined parameter radio transceiver;
a database, containing geolocation indexed parameters defining constraints on operation of the software-defined parameter radio transceiver; and
computer executable code, which is adapted to control the processor to constrain operation of the software-defined parameter radio transceiver selectively in dependence on the geolocation indexed parameters.

2. The transceiver according to claim 1, wherein the software-defined parameter radio transceiver, the processor, geolocation determining system, and the database, are provided within a common housing.

3. The transceiver according to claim 1, wherein the software-defined parameter radio transceiver and the geolocation determining system are provided within respectively different housings.

4. The transceiver according to claim 3, wherein the software-defined parameter radio transceiver receives the geolocation indexed parameters from the database through a wireless communication link.

5. The transceiver according to claim 1, wherein the processor is configured to defines default parameters of operation if the information from the database is unavailable.

6. The transceiver according to claim 1, wherein the geolocation indexed parameters defining constraints on operation comprise radio frequency transmission limits mandated by a set of rules.

7. The transceiver according to claim 1, wherein the geolocation indexed parameters defining constraints on operation comprise license restrictions on radio frequency transmission.

8. The transceiver according to claim 1, wherein the geolocation indexed parameters defining constraints on operation comprise quality of service tiers, wherein the processor is further configured to determine an account status for eligibility for a respective quality of service tier.

9. The transceiver according to claim 1, wherein the geolocation determining system comprises a global navigation satellite system.

10. The transceiver according to claim 1, wherein the parameters of operation for the software-defined parameter radio comprise a frequency hopping pattern, or a frequency channel of operation, an output power, and at least one of duty cycle.

11. The transceiver according to claim 1, wherein the parameters of operation for the software-defined parameter radio comprise an interference mitigation strategy with respect to other transceivers.

12. A method of operating a software-defined parameter radio transceiver having software control over at least a frequency channel of operation and output power, comprising:
establishing parameters of operation for the software-defined parameter radio, in dependence on a geolocation determined by a geolocation determining system, and a database containing geolocation indexed parameters defining constraints on operation of the software-defined parameter radio transceiver; and
controlling the software-defined parameter radio transceiver to remain within the geolocation indexed parameters defining constraints on operation selectively in dependence on the geolocation indexed parameters.

13. The method according to claim 12, further comprising communicating the geolocation indexed parameters from the database to the software-defined parameter radio transceiver through a wireless communication link.

14. The method according to claim 12, wherein the geolocation indexed parameters defining constraints on operation comprise radio frequency transmission limits are rule-based.

15. The method according to claim 12, wherein the geolocation indexed parameters defining constraints on operation are dependent on a locally-enforced transceiver operation license restriction.

16. The method according to claim 12, wherein the geolocation indexed parameters defining constraints on operation comprise quality of service tiers, wherein the processor is further configured to determine an account status for eligibility for a respective quality of service tier.

17. The method according to claim 12, wherein the parameters of operation for the software-defined parameter radio comprise an output power and a frequency channel of operation and at least one of duty cycle or a frequency hopping pattern.

18. The method according to claim 12, wherein the parameters of operation for the software-defined parameter radio comprise an interference mitigation strategy with respect to other software-defined parameter radio transceivers.

19. A transceiver system, comprising:
a software-defined radio transceiver, having software control over at least an operating frequency and output power;
a processor, configured to provide the software control over operation of the software-defined radio transceiver;
a context determining system, configured to detect a context of operation of the software-defined radio transceiver; and
a computer readable memory, configured to store non-transitory instructions executable by the processor to provide the software control, wherein the at least an operating frequency and power are selectively dependent on the determined context.

20. The transceiver system according to claim 19, wherein the software control further controls a modulation type for data communications, and the software control defines the modulation type dependent on the context.

21. The transceiver system according to claim 19, wherein the software-defined radio transceiver is housed separately from the context determining system, and has an autonomous mode of operation independent of the context determining system.

22. The transceiver system according to claim 19, wherein the software-defined radio transceiver is contained in a separate housing from the processor, and has an autonomous mode of operation independent of the processor.

23. The transceiver system according to claim 19, wherein the software-defined radio transceiver is an ad hoc radio transceiver is configured to transmit a message through a plurality of transceiver systems, each with a distinct context, comprising a multihop communication path having at least two different frequencies.
